(19) United States
(12) Patent Application Publication
(10) Pub. No.: US 2008/0212800 A1
(43) Pub. Date: Sep. 4, 2008

(54) Diaphragm for Speaker, Method for Producing Same, Speaker Using Such Diaphragm, and Apparatus Using Such Speaker

(76) Inventors: Yoshimichi Kajihara, Osaka (JP); Masaki Suzumura, Mie (JP); Shinya Mizone, Mie (JP)

Correspondence Address: WENDEROTH, LIND & PONACK L.L.P., 2033 K. STREET, NW, SUITE 800, WASHINGTON, DC, 20006, US

(21) Appl. No.: 11/883,767

(22) PCT Filed: Mar. 30, 2006
(86) PCT No.: PCT/JP06/06627

§ 371 Date: Aug. 6, 2007

(30) Foreign Application Priority Data
Apr. 20, 2005 (JP) 2005-122072

(51) Int. Cl. H04R 3/00; G10K 13/00; B29C 45/72; H04R 1/02

(52) U.S. Cl. 381/117; 181/169; 381/387; 264/328.14; 381/412

(57) ABSTRACT

A diaphragm for a loudspeaker contains resin, aramid fibers, and an organic silicon compound binding the resin with the aramid fibers. By this structure, high elasticity and high internal loss as characteristics of the aramid fibers are maintained; flexibility in the setting of properties of the diaphragm is thus increased. Accordingly, a diaphragm securing humidity resistance reliability and strength, and having a superior appearance can be provided.

### TECHNICAL FIELD

The present invention relates to a diaphragm for a loudspeaker used in various acoustic apparatuses and video apparatuses, a method for producing the same, and a loudspeaker using the same. The present invention also relates to an apparatus using this loudspeaker, such as stereo set, television set, and automobile.

### BACKGROUND ART

FIG. 6 is a cross-sectional view illustrating a conventional resin diaphragm for a loudspeaker by injection molding. Diaphragm 16 is produced by injection molding melted pellets made of resin such as polypropylene in a mold having a predetermined shape. As the resin material used for injection molding, single-species material such as polypropylene is generally used. Diaphragm 16 also may be a blend-type diaphragm formed by different types of resins for the purpose of adjusting properties of diaphragm 16 such as loudspeaker characteristics and acoustic quality.

When it is difficult to adjust the properties only by resin material, the properties are adjusted by mixing reinforcing material such as mica in resin material, thereby adjusting characteristics and an acoustic quality of a loudspeaker. Such a diaphragm is disclosed in Japanese Patent Unexamined Publication No. H2-228197, for example.

Recently, with a significant improvement of the performance of electronic apparatuses such as an acoustic apparatus and a video apparatus, loudspeakers used for these electronic apparatuses also have been required to have an improved performance in a market. To satisfy such a requirement and to improve the performance of the loudspeaker, it is essential to improve the performance of the diaphragm because the acoustic quality of the loudspeaker mainly depends on the performance of the diaphragm.

However, a conventional diaphragm is manufactured by a papermaking method, by resin injection molding, or by a press method. In other words, conventional diaphragms are mainly paper diaphragms or resin diaphragms, and are used for different applications depending on features thereof.

A paper diaphragm is advantageous in that properties can be finely set to increase flexibility in the adjustment of characteristics and an acoustic quality of a loudspeaker because aramid fibers or mica can be mixed easily in a wet-type mixing. However, such a diaphragm has disadvantages unique to paper in that its humidity resistance and water resistant reliability are poor and its production requires a great number of steps in a papermaking process.

On the other hand, a resin diaphragm obtained by injection molding has advantages in humidity resistance, water resistant reliability, dimension stability, and productivity. However, a resin diaphragm has disadvantages in that its properties cannot be finely set even when inorganic filler such as mica is used to adjust the properties. Accordingly, the adjustable range of the characteristics and the acoustic quality of the loudspeaker is very narrow.

### SUMMARY OF THE INVENTION

The present invention provides a diaphragm for a loudspeaker that has a lot of flexibility in the adjustment of characteristics and an acoustic quality. The diaphragm can secure humidity resistance, water resistant reliability, and dimension stability, and has a superior appearance and an improved productivity. The diaphragm for a loudspeaker of the present invention contains resin, aramid fibers, and an organic silicon compound for binding the resin with the aramid fibers. By this composition, high elasticity and a high internal loss as characteristics of the aramid fibers are maintained to increase the flexibility in the setting of properties of the diaphragm. Thus, a diaphragm having humidity-resistive reliability, strength, and a superior appearance can be provided.

### BRIEF DESCRIPTION OF THE DRAWINGS

FIG. 1A is a cross-sectional view illustrating a diaphragm for a loudspeaker according to an exemplary embodiment of the present invention.

FIG. 1B is an enlarged conceptual cross-sectional diagram illustrating the diaphragm shown in FIG. 1A.

FIG. 2 is a plan view illustrating the diaphragm shown in FIG. 1A.

FIG. 3 is a cross-sectional view illustrating the loudspeaker according to the exemplary embodiment of the present invention.

FIG. 4 is an outline view illustrating a mini-component stereo system according to the exemplary embodiment of the present invention.

FIG. 5 is a cross-sectional view illustrating an automobile according to the exemplary embodiment of the present invention.

FIG. 6 is a cross-sectional view illustrating a conventional diaphragm for a loudspeaker.

### REFERENCE MARKS IN THE DRAWINGS

1 diaphragm
1A resin
1B aramid fiber
1C organic silicon compound
2 magnet
3 upper plate
4 yoke
5 magnetic circuit
6 magnetic gap
7 frame
8 voice coil
9 edge
10 loudspeaker
11 enclosure
12 amplifier
13 operation section
14 min-component stereo system
15 automobile
16 diaphragm
21 speaker system
51 rear tray
52 front panel
53 driving section
54 steering
55 body
56 front wheel
57 rear wheel
58 sheet

### DETAILED DESCRIPTION OF A PREFERRED EMBODIMENT

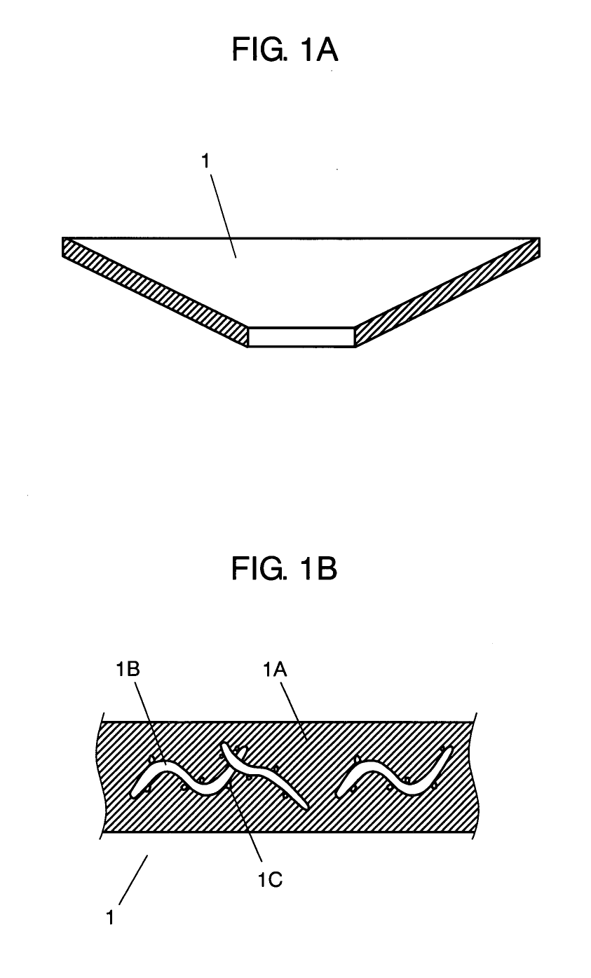

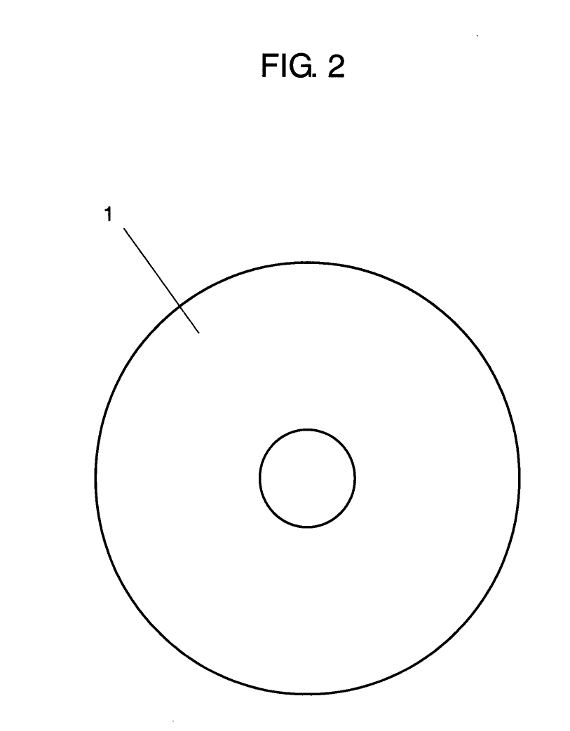

FIG. 1A is a cross-sectional view illustrating a diaphragm for a loudspeaker according to an exemplary embodiment of the present invention. FIG. 1B is an enlarged conceptual cross-sectional diagram illustrating the diaphragm shown in FIG. 1A. FIG. 2 is a plan view of the diaphragm shown in FIG. 1A. Diaphragm 1 is formed by injection molding of a material which is produced by mixing resin 1A with aramid fibers 1B and strongly binding resin 1A and aramid fibers 1B by organic silicon compound 1C. Specifically, diaphragm 1 contains resin 1A, aramid fibers 1B, and organic silicon compound 1C for binding resin 1A with aramid fibers 1B.

By mixing organic silicon compound 1C, the binding strength between resin 1A and aramid fibers 1B is increased, thereby improving the adhesion therebetween. Thus, an energy loss in diaphragm 1 is reduced, the characteristics of aramid fibers 1B are utilized more efficiently, and a diaphragm having high strength and high elasticity is obtained. In particular, when organic silicon compound 1C makes a complex of resin 1A and aramid fibers 1B, the adhesion therebetween is further improved and thus it is preferred.

Resin 1A is preferably made of crystalline or noncrystalline olefin resin. Formability improves by using olefin resin. By separately using crystalline resin material and noncrystalline resin material depending on applications, optimal properties of resin material can be obtained.

Aminosilane-based coupling agent, hydrolyzable long chain alkylsilane including 6 or more carbon atoms or the like may be used as organic silicon compound 1C. Among them, an organic silicon compound having an amino group is preferably used. By mixing organic silicon compound 1C in the material, resin 1A is bound with aramid fibers 1B more strongly. Thus, the properties of aramid fibers 1B functions effectively and diaphragm 1 having higher elasticity is obtained. As organic silicon compound 1C having an amino group, 3-aminopropyltriethoxysilane, N-2(aminoethyl)-3-aminopropyltriethoxysilane, or 3-aminopropyltrimethoxysilane is more preferable. As hydrolyzable long chain alkylsilane, hexytrimehoxysilane or decyltrimethoxysilane can be used.

Hereinafter, a specific example that polypropylene is used as resin 1A is described. First, 90 wt % of polypropylene and 10 wt % of aramid fibers having a fiber length of 3 mm are granulated and kneaded. At that time, 1.5 part by weight of 3-aminopropyltriethoxysilane as organic silicon compound 1C is added to 100 part by weight of the kneaded material. Organic silicon compound 1C can be added before kneading resin 1A and aramid fibers 1B or while kneading them.

It is preferred to heat and granulate, because polypropylene as resin 1A and aramid fibers 1B make a complex, so that the blending of resin 1A and aramid fibers 1B improves, and resin 1A and aramid fiber 1B are uniformly dispersed to each other.

Pellets are produced from the kneaded material thus prepared. Diaphragm 1 is formed by injection molding the pellets. In this manner, diaphragm 1 of sample F is made. Then, a specific gravity of diaphragm 1 is measured and subsequently a sample having a size of 32 mm×5 mm is taken out of diaphragm 1. The sample is measured with regards to the elasticity and internal loss. Diaphragms of samples A to E are made of conventional paper, resin or one of the paper and resin with 10 wt % of reinforcing material. Characteristics of samples A to E are similarly measured. The measurement results of samples A to F are shown in Table 1. It is noted that the term “internal loss” is an index showing a characteristic of material used for a diaphragm, and represents power to dissipate kinetic energy such as vibration outward when it is added from outside. The higher internal loss is, the less unnecessary reverberation is caused, providing a loudspeaker having a good acoustic quality.

TABLE 1

| | | Reinforcing | Specific | Elasticity | Internal |
|---|---|---|---|---|---|
| Sample | Main material | material | gravity | (MPa) | loss |
| A | Paper | (None) | 0.6-0.8 | 1990 | 0.048 |
| B | Paper | Kepler | 0.6-0.8 | 2400 | 0.043 |
| C | Paper | Mica | 0.6-0.8 | 2410 | 0.046 |
| D | Polypropylene | (None) | 0.91 | 1660 | 0.05 |
| E | Polypropylene | Mica | 1.1 | 2700 | 0.045 |
| F | Aramid fibers + | (None) | 0.94 | 2700 | 0.07 |
| | polypropylene | | | | |

As obviously from Table 1, diaphragm 1 made of sample F according to the present embodiment has a specific gravity smaller than that of sample E in which mica is used as reinforcing material. Furthermore, diaphragm 1 made of sample F shows higher elasticity and higher internal loss than those of samples A to C, which are conventional paper diaphragms, and samples D and E, which are conventional resin diaphragms. It has thus very effective properties.

Polypropylene is generally available easily and can be easily shaped by injection molding, however, the present invention is not limited to this. Other types of resins also can be freely used depending on prescribed characteristics. For example, when high heat resistance or high solvent resistance is required, an engineering plastic suitable for the application also can be used.

Diaphragm 1 using aramid fibers 1B can produce sound having a bright and clear tone to suppress a dark and uniform tone unique to resin.

Reinforcing material may be added in diaphragm 1 when diaphragm 1 is desired to be strengthened or when the acoustic quality is desired to be adjusted by providing resultant sound with a slight accent or by providing a peak to a sound pressure frequency characteristic. As such reinforcing material, mica, graphite, talc, or cellulose fibers can be used. When mica is mixed to the reinforcing material, the elasticity can be increased. When graphite is mixed, the elasticity and the internal loss can be increased. When talc is mixed, the internal loss can be increased. When cellulose fibers are mixed, the cellulose fibers are entangled with aramid fibers to increase the internal loss without decreasing the elasticity. Strong fibers such as carbon fibers can be used. When carbon fibers are mixed, the inflexibility and the elasticity are increased. When these materials are combined, properties of diaphragm 1 can be flexibly adjusted with a high accuracy so as to realize prescribed characteristics and an acoustic quality.

A flowability modifying material may be added in diaphragm 1. As such a modifying material, liquid paraffin, calcium stearate or the like can be used. Fatty acid having an amino group is particularly preferred as the flowability modifying material because diaphragm 1, which is highly filled with aramid fibers 1B, having a thin thickness and a light weight can be obtained by injection molding. As such fatty acid having an amino group, stearic acid amide or oleic acid amide can be used.

Table 2 shows a result of a comparison regarding flowability (MI) between when stearic acid amide is mixed as the flowability modifying material in a sample and when stearic acid amide is not mixed. The evaluation is performed in accordance with JIS K7210.

TABLE 2

| | MI |
|---|---|
| | (g/10 minutes) |
| 10% of aramid fibers | 11 |
| 10% of aramid fibers + | 15 |
| Flowability modifying material | |

As shown in Table 2, the sample mixed with the flowability modifying material clearly improves flowability in a melting condition as compared with the sample not mixed with the flowability modifying material. Thus, diaphragm 1 with a lot of flexibility in the shape can be obtained by injection molding even when aramid fibers 1B are highly filled in diaphragm 1. When the filled amounts of aramid fibers 1B are the same in the two samples, by adding the flowability modifying material, diaphragm 1 having a further thinner thickness by injection molding can be obtained.

Although this realization of prescribed characteristics and acoustic quality requires detailed technical know-how regarding how to obtain desired acoustic characteristics and sound, the prescribed characteristics and the acoustic quality are generally obtained by performing a method as described below. Specifically, the acoustic characteristics and the sound of a loudspeaker can be changed by changing parameters of the components of the loudspeaker to a certain level. By such a method, acoustic characteristics and a sound can be closer to the prescribed characteristic and acoustic quality.

For example, assume that parameters of components of a loudspeaker other than diaphragm 1 are fixed. Diaphragm 1 has variable parameters such as an area, a shape, a weight, and a thickness other than the solid state properties thereof. However, the area, the shape, the weight, and the thickness of diaphragm 1 are substantially fixed at an initial stage of the design of the loudspeaker. In other words, a sound pressure frequency characteristic and an acoustic quality of the loudspeaker are substantially determined by conditions other than the solid state properties of diaphragm 1.

In this case, unnecessary peak or dip is generated at the sound pressure frequency characteristic, and distortion is largely generated in a specific range of frequency. Furthermore, the acoustic quality causes a tone that is significantly influenced by the sound pressure frequency characteristic. Those are caused by the area, the shape, the weight, and the thickness of diaphragm 1 and are particularly attributed to the vibration mode of diaphragm 1. Such unnecessary peak, dip, or distortion can be improved to obtain a favorable acoustic quality by selecting diaphragm material in a procedure as described below.

First, such materials that presumably satisfy a sound pressure frequency characteristic, an acoustic quality, and a reliability grade required to the loudspeaker are selected as resin 1A, aramid fibers 1B, and other materials to be mixed. In this case, resin 1A as a base material is selected so that reliability such as a heat resistance grade particularly is satisfied and a unique tone of resin 1A is close to a predetermined tone.

Then, materials are selected so that unnecessary peak or dip in the sound pressure frequency characteristic can be removed. In order to remove dip, resin material having resonance with the frequency is selected. In order to remove peak, material having an internal loss at the frequency is selected. This materials are selected in consideration of density, elasticity, internal loss, a tone and a resonance frequency when the materials are formed to have a shape of diaphragm 1 which are unique to resin 1A, aramid fibers 1B, and other mixed materials.

Then, the selected materials are kneaded, so that master batch pellets highly filled with aramid fibers 1B for injection molding are produced. Next, these master batch pellets are melted to provide diaphragm 1 by injection molding.

The diaphragm thus obtained is measured and evaluated with regards to the properties and the like. A prototype of a loudspeaker is constructed with diaphragm 1 and is measured with regards to the characteristics and the acoustic quality. Finally, the sound produced by the loudspeaker is evaluated. When the evaluation does not show a prescribed characteristics and the acoustic quality, this prototyping process is repeated a plurality of times. During the processes, selecting materials and a combination ratio of the materials are improved so that the characteristics and the acoustic quality become closer to those of target, sequentially.

By repeating the process as described above, diaphragm 1 can be finished so as to satisfy the prescribed characteristics and acoustic quality or to have those very close thereto.

Aramid fiber 1B preferably has a length of 0.3 mm or more and 6 mm or less. By using aramid fibers 1B having a length within this range, an effect of making a complex of aramid fibers 1B with resin 1A by heating and granulation can be achieved efficiently, and the productivity and quality are improved. It is noted that all of aramid fibers 1B do not have to have an identical fiber length. For example, aramid fibers 1B may be provided by a combination of short fibers having a length of 0.3 or more and 1 mm or less and long fibers having a length of 1 mm or more and 6 mm or less. By using aramid fibers 1B of a combination of long fibers and short fibers as described above, resonance can be reduced and the acoustic quality can be finely adjusted.

When aramid fibers 1B have a fiber length shorter than 0.3 mm, an effect by aramid fibers 1B cannot be obtained efficiently, so that high elasticity can not be expected. On the other hand, when aramid fibers 1B have a fiber length longer than 6 mm, entangled aramid fibers 1B cause a secondary aggregation, which tends to cause a defective dispersion. Thus, it would take a long time to knead resin 1A or the aggregate of aramid fibers 1B appears at the surface of diaphragm 1 to deteriorate the appearance. In this manner, the productivity and quality decline.

It is preferable that the complex of resin 1A with aramid fibers having a length of 3 mm or less is prepared. When aramid fibers have a length longer than 3 mm, it is difficult to form diaphragm 1 to have a thin thickness.

Furthermore, aramid fibers 1B are preferably mixed in resin 1A with a mixing ratio of 5% or more and 50% or less. By this range of composition, an effect by aramid fibers 1B kneaded with resin 1A can function efficiently, and the productivity and the quality can be improved.

When aramid fibers 1B are mixed in resin 1A with a mixing ratio of 5% or less, the effect by aramid fibers 1B is substantially prevented from functioning. On the other hand, when aramid fibers 1B are mixed in resin 1A with a mixing ratio higher than 50%, it takes a long time to knead aramid fibers 1B with resin 1A. In addition, injection molding is difficult. As a result, productivity and dimensional stability decline and the flexibility in the shape is reduced.

As described above, the flexibility for setting the properties of diaphragm 1 can be increased by making diaphragm 1 by injection molding a material obtained by mixing resin 1A and aramid fibers 1B. In other words, diaphragm 1 having high elasticity and high internal loss as the characteristics of aramid fibers 1B and a humidity resistance reliability and a superior appearance is obtained. By forming diaphragm 1 as described above by injection molding, productivity and dimensional stability are also improved.

Generally, it is very difficult to fuse resin 1A with aramid fibers 1B. Thus, resin 1A and aramid fibers 1B are generally layered as a sheet-like shape and the layered material is subsequently formed into a diaphragm by a heat press. However, binding resin 1A and aramid fibers 1B with organic silicon compound 1C can make diaphragm 1 to have a thinner thickness and durability. Furthermore, diaphragm 1 can be formed by injection molding, which improves the productivity.

Although injection molding is applied in the present embodiment, the present invention is not limited to this. For example, diaphragm 1 also may be formed by producing a sheet by a solution casting method using materials such as PP resin, aramid fibers and the like, and pressing the sheet by molds from the upper and lower sides. However, diaphragm 1 having a thin thickness is preferably formed by injection molding because injection molding suppresses distortion more effectively. Furthermore, when organic silicon compound 1C is used, diaphragm 1 can have a thickness of 0.2 mm or more and 0.5 mm or less and more preferably a thickness of 0.2 mm or more and 0.3 mm or less, even when injection molding is applied. Thus, diaphragm 1 having a thin thickness can be obtained and a loudspeaker having superior sound pressure characteristics can be provided.

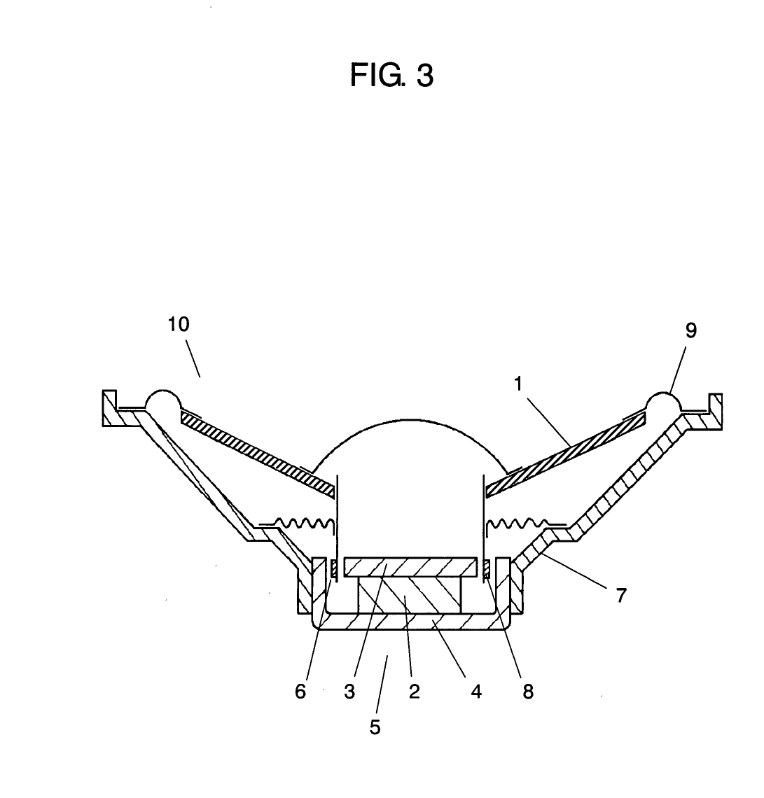

Next, loudspeaker 10 using diaphragm 1 is described. FIG. 3 is a cross-sectional view of a loudspeaker in the present embodiment. In loudspeaker 10, upper plate 3 and yoke 4 sandwich magnetized magnet 2 to form magnetic circuit 5 of internal magnetic type. Frame 7 is coupled to yoke 4 of magnetic circuit 5. A periphery of frame 7 is coupled (or bonded) to an outer circumference of diaphragm 1 via edge 9. The center of diaphragm 1 is coupled to one end of voice coil 8, and the other end of voice coil 8 is coupled so as to be inserted in magnetic gap 6 of magnetic circuit 5. In other words, voice coil 8 is joined to diaphragm 1 and is placed in a range within which a magnetic flux generated from magnetic circuit 5 works.

Loudspeaker 10 with a lot of flexibility in the adjustment of the characteristics and the acoustic quality, and high elasticity and high internal loss as the characteristics of aramid fibers 1B is obtained as a product with the structure as described above. Loudspeaker 10 can secure humidity resistance reliability and strength, and has a superior appearance and a high productivity.

Although the above description has described loudspeaker 10 having magnetic circuit 5 of internal magnetic type, the present invention is not limited to this. The invention also may be applied to a loudspeaker having a magnetic circuit of external magnetic type.

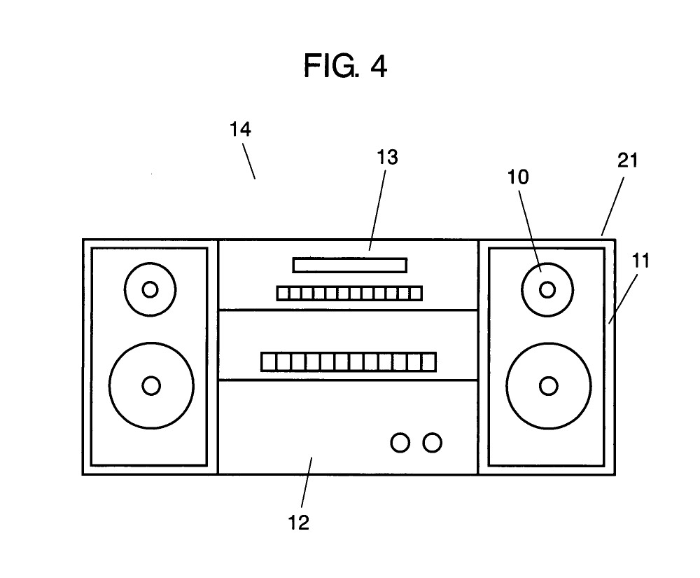

Next, an example of an apparatus using loudspeaker 10 having the structure as described above is described. FIG. 4 is an outline view illustrating a mini-component stereo system as an electronic apparatus according to the present exemplary embodiment.

Loudspeaker 10 is incorporated in enclosure 11 so as to constitute speaker system 21. Amplifier 12 includes an amplifying circuit for an electrical signal inputted to loudspeaker system 21. Operation section 13 such as a player outputs a source inputted to amplifier 12. As described above, mini-component stereo system 14 as an electronic apparatus includes amplifier 12, operation section 13, and speaker system 21. Amplifier 12, operation section 13, and enclosure 11 constitute a main body section of mini-component stereo system 14. Specifically, loudspeaker 10 is mounted to the main body section of mini-component stereo system 14. Voice coil 8 of loudspeaker 10 receives power supplied from amplifier 12 of the main body section to generate sound from diaphragm 1. This structure can provide mini-component stereo system 14 having highly-accurate characteristics, sound, and design that has been conventionally unachievable.

Although mini-component stereo system 14 is described as an application to an apparatus of loudspeaker 10, the invention is not limited to this. The invention also can be applied to a portable audio apparatus, the charging system thereof, and the like. The invention also can be widely applied to a video apparatus such as liquid crystal television, plasma display television, an information communication apparatus such as mobile phone, or an electronic apparatus such as a computer-related apparatus.

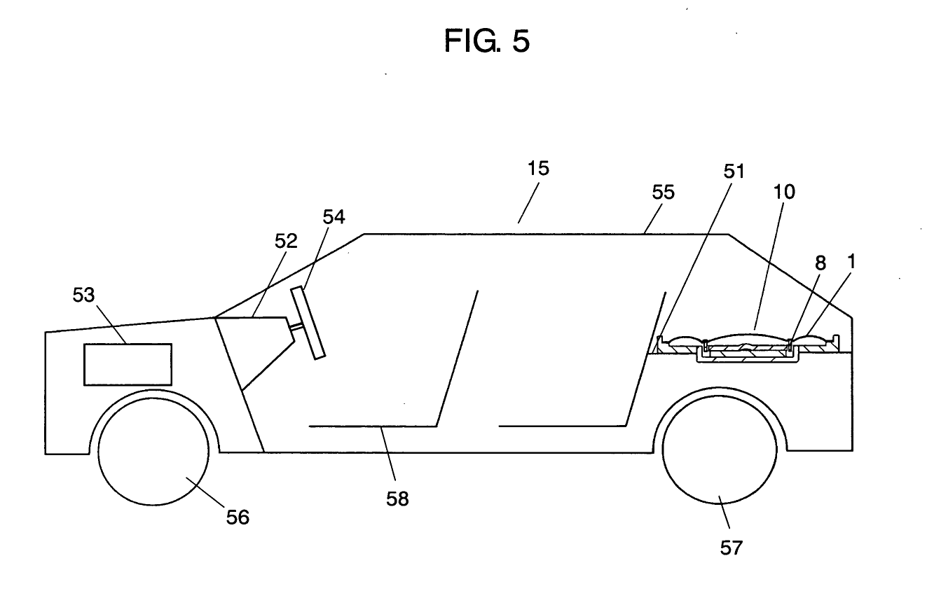

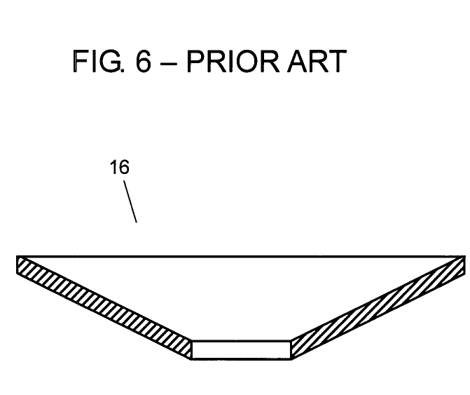

Next, another example of an apparatus using loudspeaker 10 is described. FIG. 5 is a cross-sectional view illustrating automobile 15 as equipment (an apparatus) according to the exemplary embodiment of the present invention.

Automobile 15 has body 55, seats 58, driving section 53, steering 54, front wheels 56, and rear wheels 57. Seats 58 and steering 54 are provided in a vehicle interior in body 55 and driving section 53 is provided in a machine room in body 55, respectively. Steering 54 is used to operate front wheels 56 as steering wheels. Driving section 53 has an engine or a motor and drives rear wheels 57 as drive wheels. Alternatively, driving section 53 may drive front wheels 56. Front wheels 56 and rear wheels 57 support body 55. Loudspeaker 10 is incorporate with rear tray 51 provided in body 55 of automobile 50 and is used as a part of a car audio system. In this structure, loudspeaker 10 is mounted in automobile 15 as a main body section. Voice coil 8 of loudspeaker 10 receives power supplied from automobile 15 as a main body section to generate sound from diaphragm 1.

The structure as described above can achieve highly-accurate characteristics, sound, and design utilizing the characteristics of aramid fibers 1B of loudspeaker 10. Thus, equipment (an apparatus) such as automobile 15 including loudspeaker 10 therein can improve flexibility in the acoustic design.

Loudspeaker 10 may be mounted in front panel 52 so that loudspeaker 10 is used as a part of a car navigation system or a car audio system.

### INDUSTRIAL APPLICABILITY

A diaphragm for a loudspeaker according to the present invention and a loudspeaker using the diaphragm can be applied to electronic apparatuses such as video acoustic apparatuses and information communication apparatuses, and equipment such as automobiles and the like which require a highly-accurate acoustic characteristics and sound.

1. A diaphragm for a loudspeaker comprising:
a resin;
aramid fibers; and
an organic silicon compound binding the resin with the aramid fibers.

2. The diaphragm for a loudspeaker according to claim 1, wherein
the diaphragm has a thickness of at thinnest 0.2 mm and at thickest 0.5 mm.

3. The diaphragm for a loudspeaker according to claim 1, wherein
the resin and the aramid fibers are made in a complex.

4. The diaphragm for a loudspeaker according to claim 1, wherein
the resin is a crystalline olefin resin.

5. The diaphragm for a loudspeaker according to claim 1, wherein
the resin is a noncrystalline olefin resin.

6. The diaphragm for a loudspeaker according to claim 1, wherein
the resin is polypropylene.

7. The diaphragm for a loudspeaker according to claim 1, wherein
the resin is an engineering plastic.

8. The diaphragm for a loudspeaker according to claim 1, wherein
the diaphragm further includes a reinforcing material.

9. The diaphragm for a loudspeaker according to claim 8, wherein
the reinforcing material is at least any of mica, graphite, talc, and cellulose fibers.

10. The diaphragm for a loudspeaker according to claim 1, wherein
the diaphragm further includes a flowability modifying material.

11. The diaphragm for a loudspeaker according to claim 10, wherein
the flowability modifying material is fatty acid having an amino group.

12. The diaphragm for a loudspeaker according to claim 1, wherein
the organic silicon compound has an amino group.

13. The diaphragm for a loudspeaker according to claim 1, wherein
a fiber length of the aramid fibers is at shortest 0.3 mm and at longest 6 mm.

14. The diaphragm for a loudspeaker according to claim 13, wherein
the fiber length of the aramid fibers is at longest 3 mm.

15. The diaphragm for a loudspeaker according to claim 1, wherein
the resin is mixed with the aramid fibers with a mixing ratio of at least 5% and at most 50%.

16. A loudspeaker comprising:
a magnetic circuit,
a frame coupled to the magnetic circuit;
a diaphragm containing resin, aramid fibers, and an organic silicon compound binding the resin with the aramid fibers, the diaphragm being coupled to a periphery of the frame; and
a voice coil coupled to the diaphragm and placed in a range within which a magnetic flux generated from the magnetic circuit functions.

17. An apparatus comprising:
a main body section;
a loudspeaker configured to receive power supplied from the main body section, the loudspeaker including:
a magnetic circuit;
a frame coupled to the magnetic circuit;
a diaphragm containing resin, aramid fibers, and an organic silicon compound binding the resin with the aramid fibers, the diaphragm being coupled to a periphery of the frame;
a voice coil coupled to the diaphragm and placed in a range within which a magnetic flux generated from the magnetic circuit functions.

18. The apparatus according to claim 17, wherein
the main body section includes at least a circuit configured to amplify a signal inputted to the loudspeaker.

19. The apparatus according to claim 17, wherein
the main body section has:
a body;
a driving section provided in the body;
a drive wheel configured to be driven by the driving section and to support the body;
a steering provided in the body; and
a steering wheel configured to be operated by the steering; and
the loudspeaker is provided in the body.

20. A method for manufacturing a diaphragm for a loudspeaker comprising:
A) preparing a kneaded material of resin, aramid fibers, and an organic silicon compound for binding the resin with the aramid fibers; and
B) shaping the kneaded material.

21. The method for manufacturing a diaphragm for a loudspeaker according to claim 20, wherein
the kneaded material is shaped by injection molding in step B.

22. The method for manufacturing a diaphragm for a loudspeaker according to claim 20, wherein
the kneaded material is made into a complex by heating and granulating in step A.
